(19) United States
(12) Patent Application Publication
(10) Pub. No.: US 2008/0002588 A1
(43) Pub. Date: Jan. 3, 2008

(54) Method and apparatus for routing data packets in a global IP network

(76) Inventors: Sherry L. McCaughan, Quinton, VA (US); Han Q. Nguyen, Marlboro, NJ (US); Samir Saad, Ocean, NJ (US); James Uttaro, Staten Island, NY (US)

Correspondence Address: AT&T CORP., ROOM 2A207, ONE AT&T WAY, BEDMINSTER, NJ, 07921, US

(21) Appl. No.: 11/478,892

(22) Filed: Jun. 30, 2006

(51) Int. Cl. H04J 3/14; H04L 12/56

(52) U.S. Cl. 370/238; 370/401

(57) ABSTRACT

A method and apparatus for optimally routing a data packet through multiple autonomous networks. A data packet received at an ingress node of a first autonomous network is routed to an egress node of a second autonomous network by selecting an optimal route based on the lowest latency using internal gateway protocol (IGP) routing information of the first and second autonomous networks, which is distributed to nodes of the first and second autonomous network. The data packet is then transmitted along the selected optimal route.

### BACKGROUND OF THE INVENTION

The present invention is generally directed to an intra-provider inter-AS (Autonomous System) global IP (Internet Protocol) network. More specifically, the present invention is directed to a method and system for providing optimal routing for VPN (Virtual Private Network) service traffic and MIS (Managed Internet Service) traffic in an intra-provider global IP network.

An intra-provider global network is a group of interconnected regional networks administered by the same provider. FIG. 1 illustrates a conventional intra-provider global IP network. As illustrated in FIG. 1, the conventional intra-provider global IP network includes a plurality of autonomous systems 110, 120, and 130. An autonomous system is a network having common administration and routing policies. The autonomous networks 110, 120, and 130 can correspond to geographic regions, such as an Asia/Pacific (AP) region 110, a United States (USA) region 120, and a Europe, Middle East and Africa (EMEA) region 130. The autonomous networks 110, 120, and 130 communicate with each other through Autonomous System Border Routers (ASBRs) 112, 114, 116, 122, 124, 126, 128, 132, 134, and 136. More than one pair of ASBRs can interconnect neighboring autonomous networks in order to provide redundant connectivity between the neighboring autonomous networks. For example, as illustrated in FIG. 1, the pairs of ASBRs 126 and 136, and 128 and 134 interconnect the neighboring autonomous networks 120 and 130.

Within each autonomous network 110, 120, and 130, data packets are routed using an Interior Gateway Protocol (IGP). An IGP is a protocol for exchanging internal routing information between nodes within an autonomous network. Commonly used IGP's include Open Shortest Path First (OSPF) protocol and Intermediate System to Intermediate System (IS-IS protocol). The IGP in an autonomous network is used to specify how data packets are routed optimally between nodes in the autonomous network.

For routing between the autonomous networks 110, 120, and 130 an external Border Gateway Protocol (BGP) is used. When a packet is routed to a destination address from a first autonomous network to a second autonomous network, a node in the first autonomous network selects which ASBR to send the packet to based on BGP. BGP advertises the destination address within the first autonomous network and specifies an ASBR address as the next hop along the path to the destination address. However, the use of BGP does not ensure optimal path selection when routing across autonomous networks.

FIG. 2 illustrates selecting a routing path in a conventional global IP network. As illustrated in FIG. 2, a packet is sent from a customer edge (CE) 202 of a virtual private network (VPN) site 200 connected to a first autonomous network 210 to a customer edge (CE) 232 of a VPN site 230 connected to a second autonomous network 220. A provider edge (PE) 212 of the first autonomous network 210 receives the packet from CE 202. The packet is then routed within the first autonomous network 210 to an exit ASBR 214 connected to an ingress ASBR 224 in the second autonomous network 220 using the IGP routing protocol of the first autonomous network 210. The ingress ASBR 224 in the second autonomous network 220 routes the packet within the second autonomous network 220 to the egress provider edge (PE) 222 using the IGP routing protocol of the second autonomous network 220. PE 222 transmits the packet to CE 232. In FIG. 2, the first autonomous network 210 includes ASBR 214 and ASBR 216 which respectively communicate with ASBR 224 and ASBR 226 of the second autonomous network 220. PE 212 uses BGP to select either ASBR 214 or ASBR 216 as the next hop along the path to the destination address of CE 232. This can lead to a “hot potato routing” effect, in which PE 212 chooses the shortest path out of the first autonomous region 210. For example, in FIG. 2, a path X1 between PE 212 and ASBR 214 is shorter than a path X3 between PE 212 and ASBR 216. Thus, PE 212 selects ASBR 214 in order to get the packet to the second autonomous network 220 as quickly as possible. ASBR 214 then transmits the packet to ASBR 224 of the second autonomous network 210, which routes the packet to PE 222. Although the path X1 between the PE 212 and ASBR 214 is shorter than the path X3 between PE 212 and ASBR 216, a path X2 between ASBR 224 and PE 222 can be longer than a path X4 between ASBR 226 and PE 222, such that a total path X3+X4 between PE 212 and PE 222 using ASBR 216 and ASBR 226 is shorter than a total path X1+X2 using ASBR 214 and ASBR 224. Accordingly, PE 212 selects a non-optimal route across the first and second autonomous networks 210 and 220 to the destination address of CE 232.

In addition to non-optimal routing across regional networks, it is extremely difficult for conventional intra-provider inter-AS global IP networks to provide transparent class of service treatment for MIS. Short of altering the Quality of Service (QoS) classifications of these packets, a conventional intra-provider inter-AS global network cannot offer class of service differentiation across multiple regions. Furthermore, it is difficult for conventional intra-provider inter-AS global IP networks to support emerging technologies, such as Inter-region Ethernet over MPLS (EOMPLS), Inter-region Virtual Private Line Service (VLPS), and Inter-region Internet Protocol version 6 (IPv6).

### BRIEF SUMMARY OF THE INVENTION

The present invention provides a method and apparatus for routing data packets in a global IP network, which achieves optimal routing across multiple autonomous networks. This is accomplished by distributing Internal Gateway Protocol (IGP) information between separate autonomous networks. The distributed IGP information allows edge routers to optimally route data packets to edge routers in other autonomous networks using the IGP information of each autonomous network. Furthermore, external Border Gateway Protocol (eBGP) information is shared between autonomous networks via a control plane which is separate from links which transmit data between the autonomous networks. The eBGP information is used to locate which autonomous system border router (ASBR) should be used as an egress node of an autonomous network. Thus, a router uses the shared eBGP information along with the distributed IGP information to locate an edge router of another autonomous network and select a route to the edge router of the other autonomous network.

In one embodiment of the present invention, Multiprotocol Label Switching (MPLS) is used to route data packets across autonomous networks. This is accomplished by setting up a label switched path from an ingress edge router in an autonomous network to an egress edge router in another autonomous network. Thus, a data packet can be assigned a label corresponding to a route across multiple autonomous networks. In addition to providing optimal routing, using MPLS across autonomous networks of a global IP network preserves Quality of Service (QoS) classifications and supports emerging technologies, such as Inter-region Ethernet over MPLS (EOMPLS), Inter-region Virtual Private Line Service (VLPS), and Inter-region Internet Protocol version 6 (IPv6).

These and other advantages of the invention will be apparent to those of ordinary skill in the art by reference to the following detailed description and the accompanying drawings.

### BRIEF DESCRIPTION OF THE DRAWINGS

FIG. 1 illustrates a conventional intra-provider inter-autonomous system (AS) global IP network;

FIG. 2 illustrates routing in a conventional intra-provider inter-AS global IP network;

FIG. 3 illustrates an intra-provider inter-AS global IP network according to an embodiment of the present invention;

FIG. 4 illustrates optimal routing in a global IP network according to an embodiment of the present invention;

FIG. 5 illustrates a method of routing a data packet through multiple autonomous networks according to an embodiment of the present invention; and

FIG. 6 illustrates a high level block diagram of a computer capable of implementing a method of routing a data packet through multiple autonomous networks according to an embodiment of the present invention.

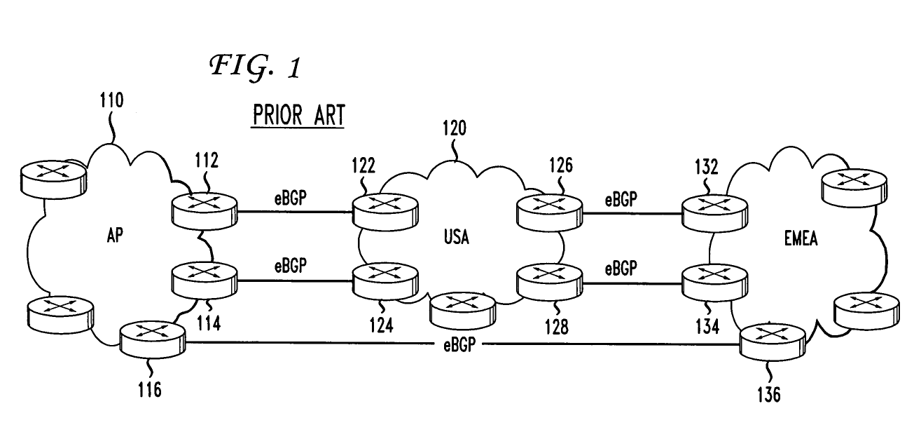

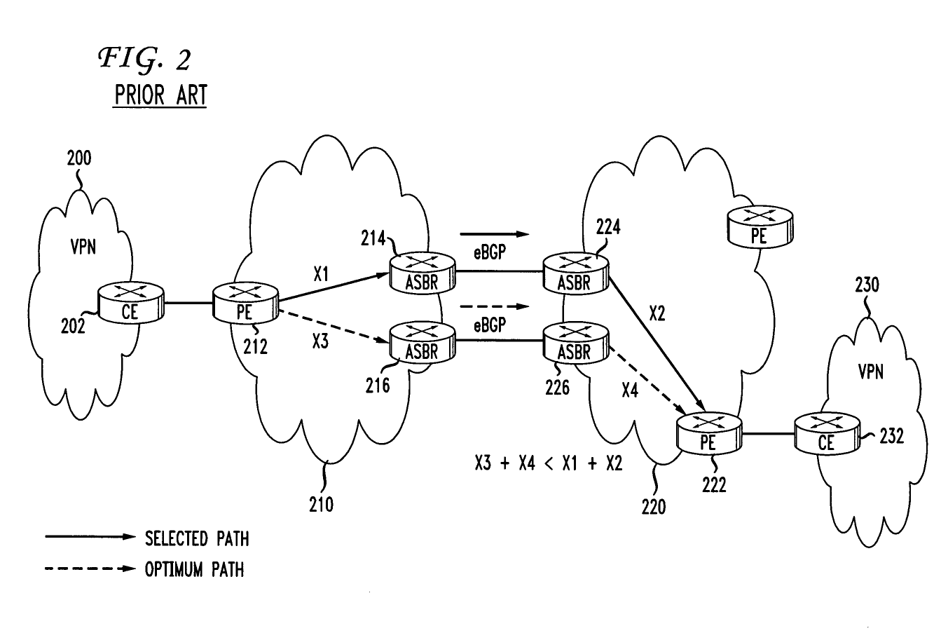

### DETAILED DESCRIPTION

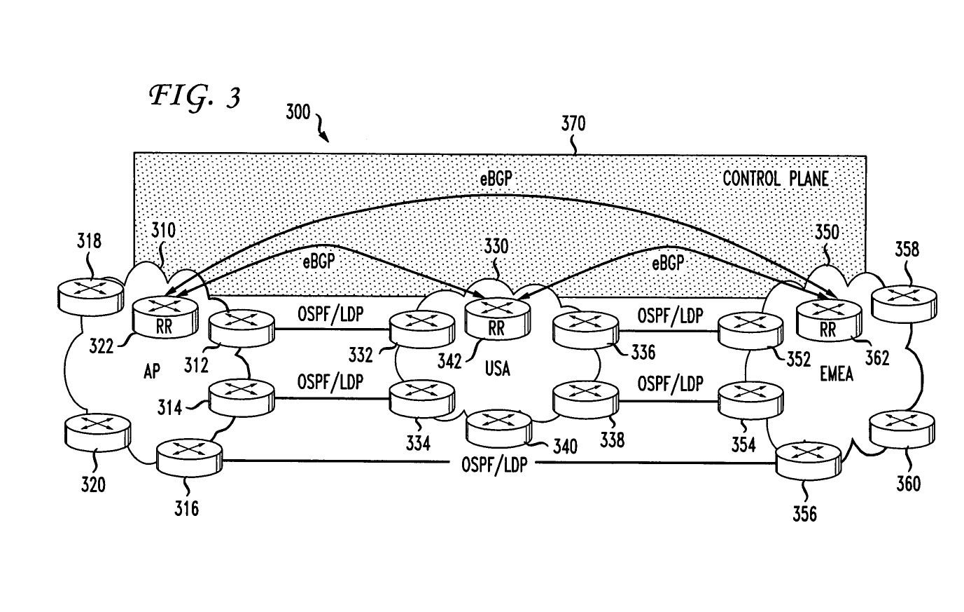

FIG. 3 illustrates a global IP network 300 in which an embodiment of the present invention may be implemented. The global IP network 300 includes a plurality of autonomous networks 310, 330, and 350. As illustrated in FIG. 3, the autonomous networks 310, 330, and 350 can correspond to separate geographical regions, such as an Asia Pacific (AP) region 310, a United States region (USA) region 330, and a Europe, Middle East and Africa (EMEA) region 350. The autonomous networks 310, 330, and 350 communicate with each other via Autonomous System Border Routers (ASBR) 312, 314, 316, 332, 334, 336, 338, 352, 354, and 356. As illustrated in FIG. 3, ASBR 312 and ASBR 314 in the AP autonomous network 310 are respectively connected to ASBR 332 and ASBR 334 in the USA autonomous network 330, ASBR 316 in the AP autonomous network 310 is connected to ASBR 356 of the EMEA autonomous network 350, and ASBR 336 and ASBR 338 of the USA autonomous network 330 are respectively connected to ASBR 352 and ASBR 354 of the EMEA network 350. Each autonomous network 310, 330, and 350 also include one or more provider edges (PEs) 318, 320, 340, 358, and 360, each of which is capable of connecting a plurality of clients to the respective autonomous network 310, 330, or 350. The PEs 318, 320, 340, 358, and 360 can serve as ingress nodes to input data packets from a client into the respective autonomous network 310, 330, or 350, or an egress node to output data packets from the respective autonomous network 310, 330, or 350 to a client. Although not illustrated in FIG. 3, each of the autonomous networks 310, 330, and 350 can also include other nodes (i.e., routers) to route data packets between the illustrated nodes in each autonomous network 310, 330, and 350.

Each of the autonomous networks 310, 330, and 350 utilizes an Interior Gateway Protocol (IGP) to route data within the autonomous network. For example, an Open Shortest Path First (OSPF) protocol may be used by each autonomous network 310, 330, and 350 as the IGP, but the present invention is not limited thereto. Within each autonomous network 310, 330, and 350 IGP routing information is distributed to all the nodes in the respective autonomous network 310, 330, or 350. The IGP routing information of a given autonomous network 310, 330, or 350 is stored in a routing table in each node of the respective autonomous network 310, 330, or 350. Using this IGP routing information, any node in an autonomous network 310, 330, or 350 can select an optimal path to any other node within that autonomous network 310, 330, or 350.

Each autonomous network 310, 330, and 350 can also use Multiprotocol Label Switching (MPLS) label distribution protocol to assign labels to its IGP routes. When using MPLS, the header information of an incoming data packet is analyzed by an autonomous network ingress provider edge (PE) which imposes a label header into the data packet. A label is assigned to the data packet based on a destination address field of the header information, and the data packet is routed across the autonomous network 310, 330, or 350 based on the label. Label distribution protocol information is distributed between the nodes in an autonomous network 310, 330, or 350. Commonly used label distribution protocols include the Label Distribution Protocol (LDP) and the RSVP protocol. A label distribution protocol distributes to every node in an autonomous network 310, 330, or 350 label binding information to each route in its IGP routing table. The label binding information of a label to an IGP route is of local significance to a node. Label binding information is stored in MPLS forwarding tables at the nodes and specifies how to switch a data packet from an incoming interface to an outgoing interface of the node based on the label header of the incoming data packet. At subsequent nodes (i.e., hops) within an autonomous network 310, 330, or 350, the label of a data packet is swapped and the data packet is forwarded using the MPLS forwarding tables stored at the nodes in the autonomous network 310, 330, or 350.

In the global IP network 300 according to the present invention, IGP routing data is also distributed between the autonomous networks 310, 330, and 350. The IGP routing information is distributed from each autonomous network 310, 330, and 350 into neighboring autonomous networks 310, 330 and 350 via the ASBRs 312, 314, 316, 332, 334, 336, 338, 340, 352, 354, and 356. The IGP routing information that is distributed between the autonomous networks 310, 330, and 350 includes location information for the PEs 318, 320, 340, 358, and 360 of the autonomous networks 310, 330, and 350. The location information of the PEs 318, 320, 340, 358, and 360 can include a loopback interface address of each PE 318, 320, 340, 358, and 360. This IGP information is distributed to all nodes including the PEs 318, 320, 340, 358, and 360 of each autonomous network 310, 330, and 350, so that each PE 318, 320, 340, 358, and 360 is aware of the PEs 318, 320, 340, 358, and 360 in other autonomous networks 310, 330, and 350. Accordingly, a PE 318, 320, 340, 358, or 360 can calculate an optimal path to any other PE 318, 320, 340, 358, or 360 in the global IP network 300. The label binding information is also distributed between the autonomous networks 310, 330, and 350 via the ASBRs 312, 314, 316, 332, 334, 336, 338, 340, 352, 354, and 356. This allows MLPS to be utilized when routing packets between autonomous networks 310, 330, and 350.

When IGP and label binding information of an autonomous network 310, 330, or 350 is distributed into a neighboring autonomous network 310, 330, or 350, the neighboring autonomous network 310, 330, or 350 can re-distribute that IGP and label binding information into yet another autonomous network 310, 330, or 350, that neighbors the neighboring autonomous network 310, 330, or 350. For example, when the IGP and label binding information of the AP autonomous network 310 is distributed from ASBR 312 and ASBR 314 into the USA autonomous network 330 via ASBR 332 and ASBR 334, respectively, the IGP and label binding information of the AP autonomous network 310 can be redistributed from ASBR 336 and ASBR 338 into the EMEA autonomous network 350 via ASBR 352 and ASBR 354, respectively. Thus, when routing a data packet to a PE 318 or 320 of the AP autonomous network 310, a PE 358 or 360 of the EMEA autonomous network 350 can consider a route through the USA autonomous network 330. The IGP and label binding information of the AP autonomous network 310 is also distributed from ASBR 316 into the EMEA autonomous network 350 through ASBR 356, so the PE 358 or 360 of the EMEA autonomous can select the optimum route among all possible routes to the PE 318 or 320 of the AP autonomous network 310.

It is also possible that an autonomous network 310, 330, or 350 be configured not to re-distribute IGP and label binding information of a neighboring autonomous network 310, 330, or 350 to another neighboring network. For example, the AP autonomous network 310 can be configured not to re-distribute the IGP and label binding information of the EMEA autonomous network 350 to the USA autonomous network 310. In this case, when routing a data packet to a PE 358 or 360 of the EMEA autonomous network 350, a PE 340 of the USA autonomous network 330 does not consider paths through the AP autonomous network 310. This may be desirable when the infrastructure of one autonomous network 310, 330, or 350, is not capable of handling traffic demands of network traffic transmitted from another autonomous network 310, 330, or 350.

As illustrated, in FIG. 3, each autonomous network 310, 330, and 350 further includes at least one route reflector 322, 342, and 362. Each route reflector 322, 342, and 362 transmits external Border Gateway Protocol (eBGP) information of its respective autonomous network 310, 330, and 350 to the other route reflectors 322, 342, and 362. The route reflectors 322, 342, and 362 form a control plane 370 between the autonomous networks 310, 330, and 362, such that the eBGP information is shared over the control plane 370 instead of being transmitted via the ASBRs 312, 314, 316, 332, 334, 336, 338, 340, 352, 354, and 356. The eBGP information includes IP addresses of clients connected to the PEs 318, 320, 340, 358, or 360 and information regarding a “next hop” for each of the clients. The “next hop” information can include the loopback interface address of the PE 318, 320, 340, 358, or 360 to which a client is connected. When a PE (“ingress node”) 318, 320, 340, 358, or 360 of an autonomous network 310, 320, or 330 receives a data packet from a client to be transmitted to another client connected to a PE (“egress node”) 318, 320, 340, 358, or 360 of another autonomous network 310, 330, or 350, the ingress node 318, 320, 340, 358, or 360 determines the which PE 318, 320, 340, 358, or 360 is the egress node using the eBGP information, and selects an optimum routing path to the egress node using the distributed IGP information and label binding information.

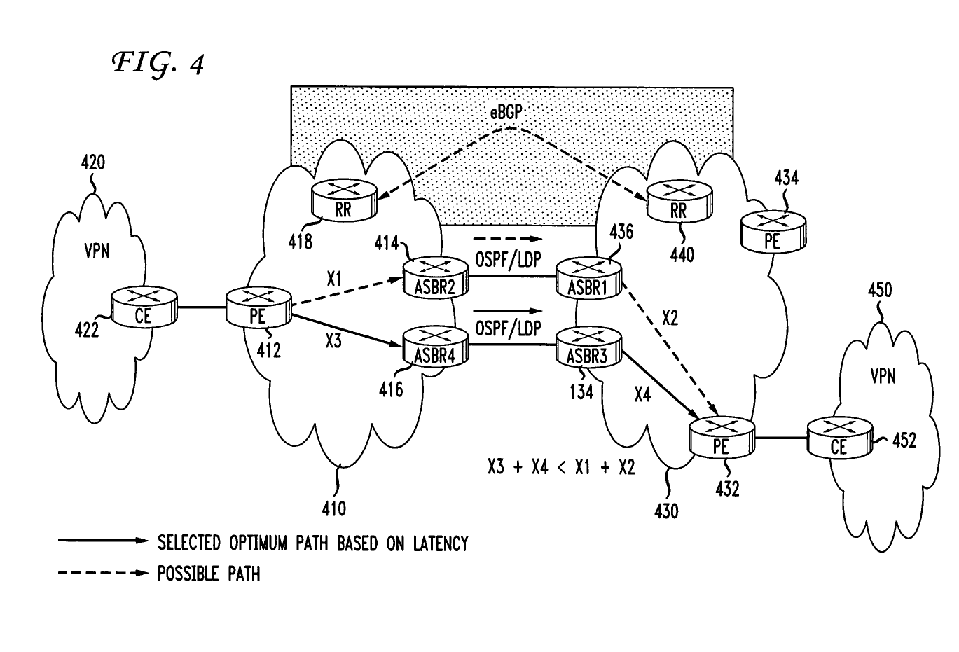

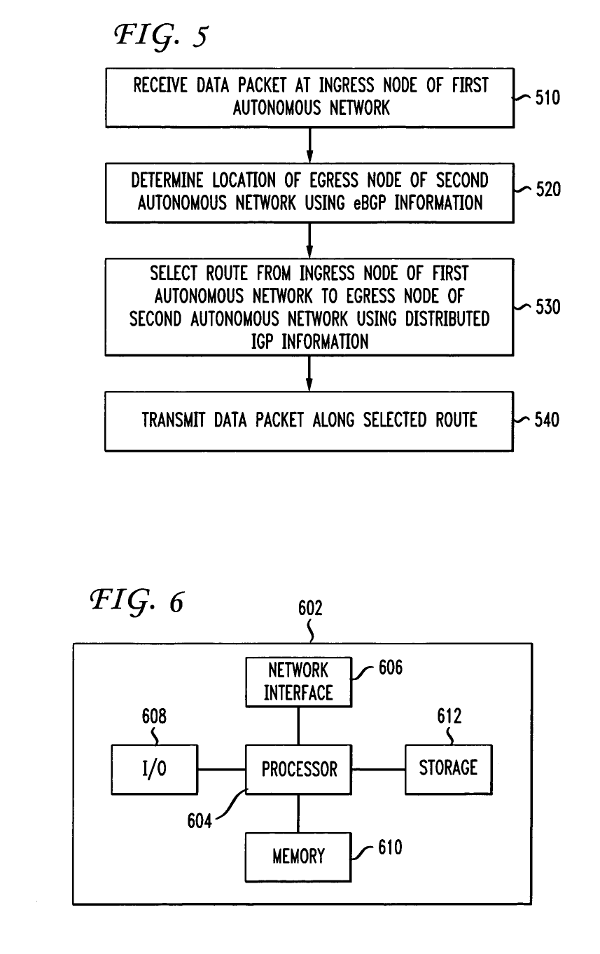

FIG. 4 illustrates optimum routing in a global IP network 400 according to an embodiment of the present invention. As illustrated in FIG. 4, the global IP network 400 includes a first autonomous network 410 having a PE 412, ASBRs 414 and 416, and a route reflector 418, and a second autonomous network 430 having PEs 432 and 434, ASBRs 436 and 438, and a route reflector 440. PE 412 of the first autonomous network is connected to a customer edge (CE) 422 of a virtual private network (VPN) site 420, and PE 432 of the second autonomous network 430 is connected to a CE 452 of the VPN site 450. FIG. 5 illustrates a method for routing a data packet through multiple autonomous systems according to an embodiment of the present invention. This method will be described while referring to FIGS. 4 and 5.

At step 510, an ingress node of a first autonomous network receives a data packet. In FIG. 4, PE 412 receives a data packet transmitted from CE 422. The data packet contains header information including a destination address. In this case the destination address specifies the IP address of CE 452.

At step 520, the ingress node determines the location of the egress node of a second autonomous network using eBGP information exchanged between route reflectors 418 and 440 of the first and second autonomous networks 410 and 430. PE 412 uses the eBGP information exchanged between the first and second autonomous networks 410 and 430 to determine that PE 432 is the egress node which connects to CE 452. That is, based on the destination IP address in the header of the data packet, PE 412 uses the eBGP information to determine that the next hop to the destination IP address is the loopback interface address of PE 432.

At step 530, the ingress node selects a route from the ingress node to the egress node using IGP information of the second autonomous network distributed into the first autonomous network. For example, in FIG. 4, the first and second autonomous networks 410 and 430 use OSPF as the IGP. OSPF information of the second autonomous network 430 is distributed into the first autonomous network 410 via the ASBRs 414, 416, 436, and 438. The OSPF information of the second autonomous network 430 includes values X2 and X4, representing the latency of a path between ASBR 436 and PE 432 and the latency of a path between ASBR 438 and PE 432, respectively. PE 412 uses the values X2 and X4 along with values X1 and X3, representing the latency of a path between PE 412 and ASBR 414 and the latency of a path between PE 412 and ASBR 416, respectively, and known from its own autonomous network OSPF, to select the route between PE 412 and PE 432 with the lowest latency. As illustrated in FIG. 4, if X3+X4 is less than X1+X2, PE 412 routes the route through ASBR 416 and ASBR 438 because it has a lower latency than the route through ASBR 414 and ASBR 436.

At step 540, the ingress node of the first autonomous network transmits the data packet along the selected route. PE 412 transmits the data packet to a first of sequential hops along the selected optimal route between PE 412 and PE 432. If the global IP network 400 utilizes MLPS, PE 412 analyzes the header of the data packet and uses distributed label binding information of the first and second autonomous networks 410 and 430 to assign a label to the data packet corresponding to the selected optimum route. The data packet is routed along the selected route based on the assigned label until the data packet reaches PE 432. When PE 432 receives the data packet, PE 432 transmits the data packet to CE 452.

The above described method can be implemented as a computer program executed by a device which functions as a router in an autonomous network. For example, the method may be implemented on a computer using well known computer processors, memory units, storage devices, computer software, and other components. A high level block diagram of such a computer is illustrated in FIG. 6. Computer 602 contains a processor 604 which controls the overall operation of the computer 602 by executing computer program instructions which define such operation. The computer program instructions may be stored in a storage device 612 (e.g., magnetic disk) and loaded into memory 610 when execution of the computer program instructions is desired. Thus, the method of routing data packets across multiple autonomous networks, as well as distributing IGP information between multiple autonomous networks, can be defined by the computer program instructions stored in the memory 610 and/or storage 612 and the method will be controlled by the processor 604 executing the computer program instructions. The computer 602 also includes one or more network interfaces 606 for communicating with other devices via a network. The computer 602 also includes input/output 608 which represents devices which allow for user interaction with the computer 602 (e.g., display, keyboard, mouse, speakers, buttons, etc.). One skilled in the art will recognize that an implementation of an actual computer will contain other components as well, and that FIG. 6 is a high level representation of some of the components of such a computer for illustrative purposes.

In addition to providing optimal routing across multiple autonomous networks, the present invention also can preserve transparency of Quality of Service (QoS) classifications in Managed Internet Service (MIS) service data packets transmitted across multiple networks. MIS service data packets in traditional intra-provider multiple autonomous networks are transmitted as unlabeled packets over the links interconnecting the autonomous networks. Transmitting these data packets as unlabeled packets exposes the customer Quality of Service (QoS) markings. Without altering customer markings to provide all customers' traffic the same QoS treatment, some customers' data packets may receive preferential QoS treatment at the expense of other customers' traffic. Because label binding information is distributed between autonomous networks, MIS service data packets are transmitted as labeled packets over the links between autonomous networks without altering the customer QoS markings. Thus, end-to-end QoS transparency can be preserved between provider edges of separate autonomous networks.

Furthermore, since the data packets can be routed over multiple autonomous networks based on labels instead of analyzing the IPv6 header information at hops in each network, autonomous system border routers (ASBRs) interconnecting the autonomous networks need not be IPv6-aware.

Also, because a provider edge of an autonomous network is aware of provider edges of other autonomous networks in the present invention, a provider edge can recognize a provider edge in another autonomous network as an exit point from a global network instead of only being able to recognize an ASBR in the same autonomous network as an exit point. Accordingly, the present invention can provide emerging technologies, such as Ethernet over MPLS (EOMPLS) and Virtual Private Line Service (VLPS) with the same support for inter-region and intra-region services.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for routing a data packet through multiple autonomous networks, comprising:
receiving a data packet at an ingress node of a first autonomous network;
selecting an optimal route from said ingress node of the first autonomous network to an egress node of a second autonomous network using internal routing information of the first and second autonomous networks; and
transmitting said data packet along the selected route.

2. The method of claim 1, wherein the internal routing information comprises separate instances of internal gateway protocol (IGP) routing information in each autonomous network.

3. The method of claim 2, wherein said selecting step comprises:
analyzing header information of said data packet to determine a destination IP address;
determining a next hop of said destination IP address as a loopback interface address of said egress node of the second autonomous network based on external Border Gateway Protocol (eBGP) information exchanged between the first and second autonomous networks; and
selecting a route from said ingress node to said egress node based on said loopback interface address of said egress node using the IGP routing information of the first and second networks.

4. The method of claim 2, wherein said IGP routing information of each of the first and second autonomous networks comprises one of Open Shortest Path First (OSPF) routing information and Intermediate System to Intermediate System (IS-IS) routing information.

5. The method of claim 1, wherein said selecting step comprises:
calculating latency on a plurality of paths between said ingress node of the first autonomous network and said egress node of the second autonomous network using said internal routing information of the first and second autonomous networks; and
selecting a path between said ingress node of the first autonomous network and said egress node of the second autonomous network with the lowest latency.

6. The method of claim 1, wherein said selecting step comprises:
selecting a shortest path between said a shortest path between said ingress node of the first autonomous network and said egress node of the second autonomous network using the internal routing information of the first and second autonomous network.

7. The method of claim 1, wherein said transmitting step comprises:
assigning a label to the data packet based on the selected route using label binding information distributed in the first and second autonomous networks;
routing the data packet from said ingress node of the first autonomous network to said egress node of the second autonomous network along an optimal shortest latency-based path using Multiprotocol Label Switching (MPLS).

8. The method of claim 1, wherein said internal routing information of the second autonomous network is distributed to nodes of the first autonomous network.

9. The method of claim 1, wherein said selecting step comprises:
selecting a route from said ingress node of the first autonomous network to said egress node of the second autonomous network through a third autonomous network using internal routing information of the first, second, and third autonomous networks.

10. The method of claim 1, wherein said first and second autonomous networks correspond to geographical regions.

11. A network router of a first autonomous network for routing a data packet to an egress node of a second autonomous network, comprising:
an interface for receiving a data packet;
a memory storing internal routing information of the first and second autonomous networks;
means for selecting an optimal route through the first and second autonomous networks to the egress node of the second autonomous network using the internal routing information of the first and second autonomous networks; and
means for transmitting said data packet along the selected optimal route.

12. The network router of claim 11, wherein said internal routing information comprises internal gateway protocol (IGP) routing information.

13. The network router of claim 12, wherein said IGP information comprises one of Open Shortest Path First (OSPF) routing information and Intermediate System to Intermediate System (IS-IS) routing information.

14. The network router of claim 11, wherein said memory further stores label binding information of the first and second autonomous systems, further comprising:
means for assigning a label to said data packet based on the selected optimal route and said label binding information.

15. An autonomous IP network, comprising:
at least one border router configured to distribute internal routing information of the autonomous IP network to a neighboring autonomous network and to receive internal routing information of the neighboring autonomous network from the neighboring autonomous network; and
at least one edge router configured to route a data packet to a node of a neighboring autonomous network using the internal routing information of the autonomous IP network and the neighboring autonomous network.

16. The autonomous IP network of claim 15, wherein said internal routing information comprises internal gateway protocol (IGP) routing information.

17. The autonomous IP network of claim 16, wherein the IGP of each of the autonomous networks comprises one of Open Shortest Path First (OSPF) and Intermediate System to Intermediate System (IS-IS).

18. The autonomous IP network of claim 15, further comprising:
at least one route reflector configured to exchange external border gateway protocol (eBGP) information with a neighboring autonomous network.

19. The autonomous IP network of claim 15, wherein the internal routing information of the neighboring autonomous IP network distributed by said at least one border router comprises location information for at least one edge router in the neighboring autonomous network.

20. The autonomous IP network of claim 15, wherein said at least one edge router comprises a memory storing the received internal routing information of the neighboring autonomous network.
